(19) United States
(12) Patent Application Publication
(10) Pub. No.: US 2026/0156231 A1
(43) Pub. Date: Jun. 4, 2026

(54) VEHICLE SURROUNDINGS MONITORING APPARATUS

(71) Applicant: TOYOTA JIDOSHA KABUSHIKI KAISHA, Aichi (JP)

(72) Inventor: Yoji ICHIKAWA, Nagoya-shi (JP)

(21) Appl. No.: 19/380,968

(22) Filed: Nov. 6, 2025

(30) Foreign Application Priority Data
Dec. 3, 2024 (JP) 2024-209908

(51) Int. Cl. H04N 7/18; G01S 19/13; G01S 19/48; H04W 4/44

(52) U.S. Cl. CPC H04N 7/188; G01S 19/13; G01S 19/48; H04N 7/183; H04W 4/44

(57) ABSTRACT

A vehicle surroundings monitoring apparatus that records a surrounding environment of a parked vehicle using a vehicle-mounted camera includes a determination unit that determines whether the vehicle is parked at a user's home by receiving a radio signal, and a recording control unit that does not record the surrounding environment of the vehicle when the determination unit determines that the vehicle is parked at the user's home.

### CROSS-REFERENCE TO RELATED APPLICATIONS

This application is based upon and claims the benefit of priority from Japanese Patent Application No. 2024-209908, filed on Dec. 3, 2024, the entire contents of which are incorporated herein by reference.

### TECHNICAL FIELD

The present disclosure relates to a vehicle surroundings monitoring apparatus.

### BACKGROUND

Conventionally, Japanese Unexamined Patent Application Publication No. 2018-200612 is known as a technical document related to a vehicle surroundings monitoring apparatus. This publication discloses a technology related to a parking monitoring function of a drive recorder. Specifically, a technology is shown that cancels automatic recording of the drive recorder based on position information of the host vehicle and information on pre-registered non-recording locations.

### SUMMARY

However, position determination by GNSS had an issue of coarse position accuracy. For this reason, there have been cases where the recording of the drive recorder could not be canceled within an appropriate range. As a result, recording has sometimes been canceled even in a location where recording should have been performed.

One aspect of the present disclosure is a vehicle surroundings monitoring apparatus. This apparatus records the surrounding environment of a parked vehicle using a vehicle-mounted camera. This apparatus includes a determination unit and a recording control unit. The determination unit determines whether or not the vehicle is parked at a user's home by receiving a radio signal. The recording control unit does not record the surrounding environment of the vehicle when the determination unit determines that the vehicle is parked at the user's home.

According to each aspect of the present disclosure, by not recording the surrounding environment of the vehicle when it is determined by radio signal reception that the vehicle is parked at the user's home, it is possible to suppress unnecessary recording at home.

### BRIEF DESCRIPTION OF THE DRAWINGS

FIG. 1 is a block diagram showing a vehicle surroundings monitoring apparatus according to a first embodiment.

FIG. 2A is a diagram for explaining an example in which an erroneous determination occurs when determining whether a vehicle is parked at home based on position information from GNSS.

FIG. 2B is a diagram for explaining an example of a case where a determination of whether a vehicle is parked at home is made based on a home Wi-Fi radio signal.

FIG. 3 is a flowchart showing an example of a vehicle surroundings monitoring process.

FIG. 4 is a block diagram showing a vehicle surroundings monitoring apparatus according to a second embodiment.

FIG. 5 is a flowchart showing an example of a vehicle surroundings monitoring process according to the second embodiment.

### DETAILED DESCRIPTION

Hereinafter, embodiments of the present disclosure will be described with reference to the drawings.

### First Embodiment

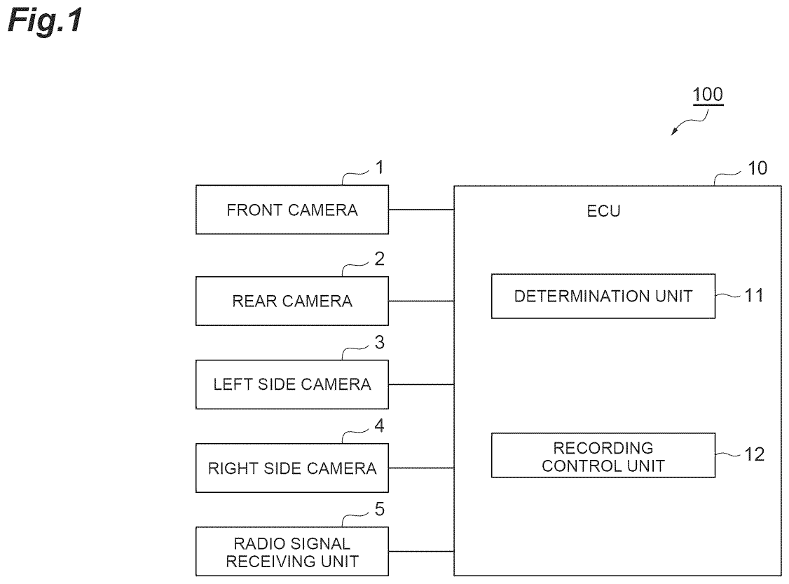

The vehicle surroundings monitoring apparatus 100 shown in FIG. 1 is an apparatus mounted on a vehicle. This apparatus monitors the surrounding environment of the parked vehicle. The vehicle surroundings monitoring apparatus 100 has a function of imaging and recording the surrounding environment when the vehicle is parked. The vehicle surroundings monitoring apparatus 100 may be configured as a drive recorder.

The vehicle surroundings monitoring apparatus 100 includes a front camera 1, a rear camera 2, a left side camera 3, a right side camera 4, a radio signal receiving unit 5, and an ECU 10 (Electronic Control Unit) that controls these components. The ECU 10 has a determination unit 11 and a recording control unit 12.

The front camera 1 is a vehicle-mounted camera installed to photograph the front of the vehicle. The front camera 1 plays a role in monitoring obstacles and situations in the traveling direction of the vehicle. The front camera 1 is typically attached to the vehicle's front grille or the back of the windshield.

The rear camera 2 is a vehicle-mounted camera installed to photograph the rear of the vehicle. The rear camera 2 plays a role in monitoring obstacles and situations at the rear during parking or reversing. The rear camera 2 is typically attached to the vehicle's rear bumper or the upper part of the rear window.

The left side camera 3 and the right side camera 4 are vehicle-mounted cameras installed to photograph the left side and the right side of the vehicle, respectively. The left side camera 3 and the right side camera 4 play a role in monitoring approaching objects and situations from the sides. The left side camera 3 and the right side camera 4 are typically attached to the vehicle's side mirrors or door panels.

The radio signal receiving unit 5 is a device that receives radio signals such as Wi-Fi or Bluetooth (registered trademark). The radio signal receiving unit 5 can distinguish the received radio signals. The radio signal receiving unit 5 detects the reception of a pre-registered radio signal. This radio signal is, for example, a home Wi-Fi radio signal or Bluetooth radio signal. When the radio signal receiving unit 5 detects the reception of this radio signal, it transmits the detection result to the ECU 10. Based on this information, the ECU 10 can determine whether or not the vehicle is parked at the user's home.

The ECU 10 is an electronic control unit having a CPU (Central Processing Unit) and a storage unit. The storage unit is composed of, for example, a ROM (Read Only Memory), a RAM (Random Access Memory), an EEPROM (Electrically Erasable Programmable Read-Only Memory), and the like. In the ECU 10, for example, various functions are realized by the CPU executing a program stored in the storage unit. The ECU 10 may be composed of a plurality of electronic units.

Next, the functional configuration of the ECU 10 will be described. The ECU 10 has a determination unit 11 and a recording control unit 12.

The determination unit 11 performs a determination related to the recording of the surroundings monitoring by the vehicle surroundings monitoring apparatus 100 when the vehicle is parked. The determination unit 11 detects the on/off state of the vehicle's ignition to determine that the vehicle is parked.

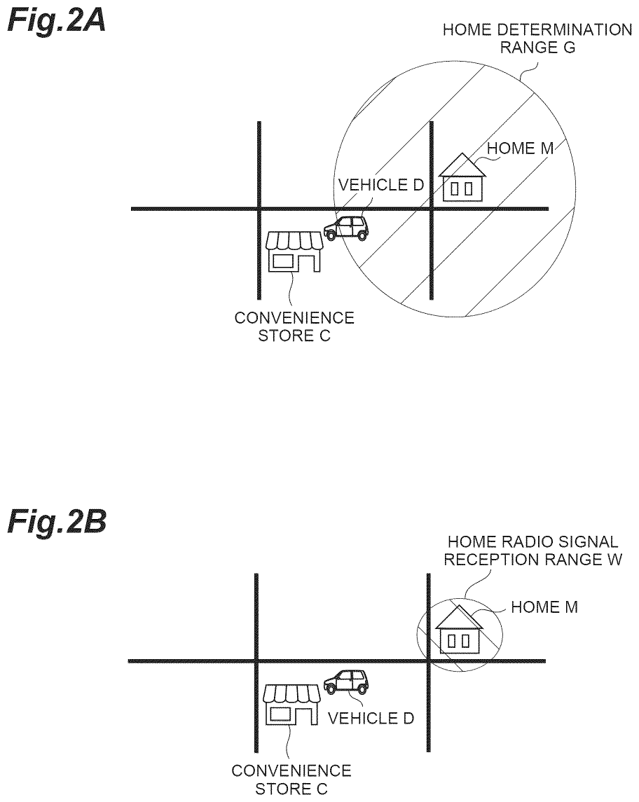

Further, the determination unit 11 determines whether or not the vehicle is parked at the user's home. Hereinafter, the function of the determination unit 11 will be described in detail with reference to FIG. 2A and FIG. 2B.

FIG. 2A shows an example of a case where a determination of whether a vehicle is parked at home is made based on position information from a GNSS (Global Navigation Satellite System) in a conventional apparatus. GPS (Global Positioning System) is an example of GNSS. In GNSS, the position determination range is made wide to absorb positioning errors or to handle locations that should not be pinpointed, such as a company parking lot. In this way, with GNSS, the position determination range is set widely. This is for accommodating positioning errors. It is also for handling locations where precise positioning should not be performed, such as a company parking lot. Since the home determination range G by GNSS is wide in this way, parking lots of stores near the home may also be erroneously determined to be around the home. For example, consider a situation where a vehicle D is parked in the parking lot of a convenience store C near a home M. Even in this case, the vehicle D is included within the home determination range G. Therefore, it may be erroneously determined that the vehicle is parked at home, and the recording may be canceled.

In contrast, FIG. 2B shows an example of a case where a determination of whether a vehicle is parked at home is made based on the radio signal of the home Wi-Fi. In this case, since the home radio signal reception range W is narrow, erroneous determinations are reduced. The home radio signal reception range W is a range where the home Wi-Fi or Bluetooth radio signal can reach.

Specifically, the determination unit 11 analyzes the Wi-Fi or Bluetooth radio signal received via the radio signal receiving unit 5. Then, when the home Wi-Fi or Bluetooth radio signal is received, it determines that the vehicle is parked at home. According to this method, even when the vehicle D is parked in the parking lot of the convenience store C near the home M, an erroneous determination does not occur. This is because that location is outside the home radio signal reception range W. In this way, the determination unit 11 accurately determines whether or not the vehicle is parked at home.

The recording control unit 12 is responsible for controlling the recording of the vehicle's surrounding environment. The recording control unit 12 starts and stops recording based on instructions from the determination unit 11. Specifically, when the vehicle is parked, the recording control unit 12 receives a determination result from the determination unit 11. When it is determined by the determination unit 11 that the vehicle is parked at the user's home, the recording control unit 12 controls so as not to perform recording of the vehicle's surrounding environment.

On the other hand, when the recording control unit 12 determines by the determination unit 11 that the vehicle is parked at a location other than home, the recording control unit 12 starts recording the vehicle's surrounding environment. This makes it possible to record the situation around the parked vehicle and improve the safety of the vehicle. For example, it becomes possible to record illegal acts such as vandalism or theft in a parking lot and check them later.

The recording control unit 12 integrates the video data from the front camera 1, the rear camera 2, the left side camera 3, and the right side camera 4, and performs recording as necessary. This enables recording that covers the entire surroundings of the vehicle, realizing comprehensive monitoring.

Furthermore, the recording control unit 12 also saves and manages the recorded data. The recorded data is typically set to be saved for a certain period and then automatically overwritten. This makes it possible to efficiently manage necessary data and optimize the storage capacity.

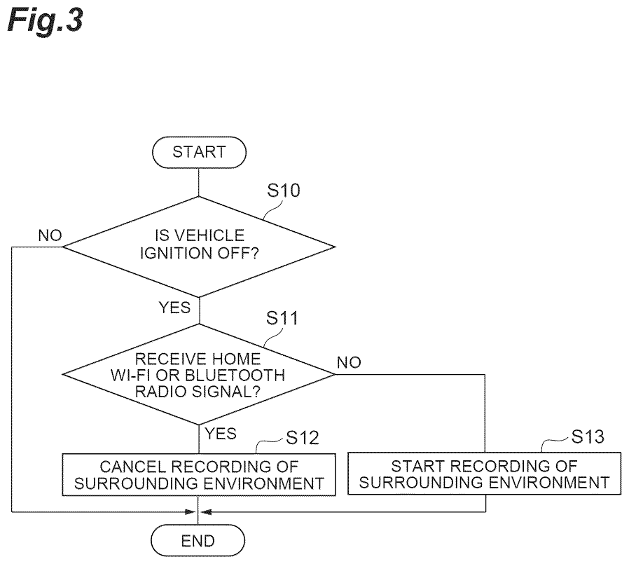

Next, the vehicle surroundings monitoring process of the vehicle surroundings monitoring apparatus 100 according to the first embodiment will be described. FIG. 3 is a flowchart showing an example of the vehicle surroundings monitoring process.

As shown in FIG. 3, first, the ECU 10 determines whether or not the vehicle's ignition has been turned off (S10). If the ECU 10 determines that the vehicle's ignition has been turned off (S10: YES), the process proceeds to S11. If the ECU 10 determines that the ignition has not been turned off (S10: NO), it does not start the vehicle surroundings monitoring process.

Next, the ECU 10 determines by the determination unit 11 whether or not a home Wi-Fi or Bluetooth radio signal has been received (S11). The determination unit 11 determines whether or not a home Wi-Fi or Bluetooth radio signal has been received via the radio signal receiving unit 5.

If it is determined that a home Wi-Fi or Bluetooth radio signal has been received (S11: YES), the ECU 10 determines that the vehicle is parked at home and proceeds to S12. If it is not determined that a home Wi-Fi or Bluetooth radio signal has been received (S11: NO), the ECU 10 determines that the vehicle is not parked at home and proceeds to S13.

In S12, the ECU 10 cancels the recording of the vehicle's surrounding environment by the recording control unit 12. This makes it possible to suppress the execution of unnecessary recording around the user's home. After that, the ECU 10 ends the current vehicle surroundings monitoring process.

In S13, the ECU 10 causes the recording control unit 12 to start recording the vehicle's surrounding environment. The recording control unit 12 records images captured by the front camera 1, the rear camera 2, the left side camera 3, and the right side camera 4. This recording is continued, for example, until a predetermined time elapses or until the vehicle's ignition is turned on. After that, the ECU 10 ends the current vehicle surroundings monitoring process.

The vehicle surroundings monitoring apparatus 100 according to the first embodiment has the following advantages. First, when it is determined by radio signal reception that the vehicle is parked at the user's home, the recording of the vehicle's surrounding environment is not performed. This can suppress unnecessary recording at home. Also, this apparatus determines whether or not the vehicle is parked at home by receiving a home Wi-Fi or Bluetooth radio signal. Therefore, an accurate determination is possible without requiring additional position information acquisition means. This also contributes to system simplification and cost reduction.

It should be noted that since Bluetooth can use smaller transmitters than Wi-Fi, it is easy to increase the areas where recording is canceled by installing them in multiple locations. It becomes easy to install not only at home but also in parking lots at the workplace.

### Second Embodiment

Next, a vehicle surroundings monitoring apparatus 200 according to a second embodiment will be described with reference to the drawings. The vehicle surroundings monitoring apparatus 200 is different from the vehicle surroundings monitoring apparatus 100 of the first embodiment in that it performs a home determination using the vehicle's position information from GNSS (GPS). The vehicle surroundings monitoring apparatus 200 assumes a situation where a home radio signal such as Wi-Fi is not received. In this situation, if it is determined from the vehicle's position information by GNSS that the vehicle is parked at home, the apparatus inquires of the user whether recording is necessary.

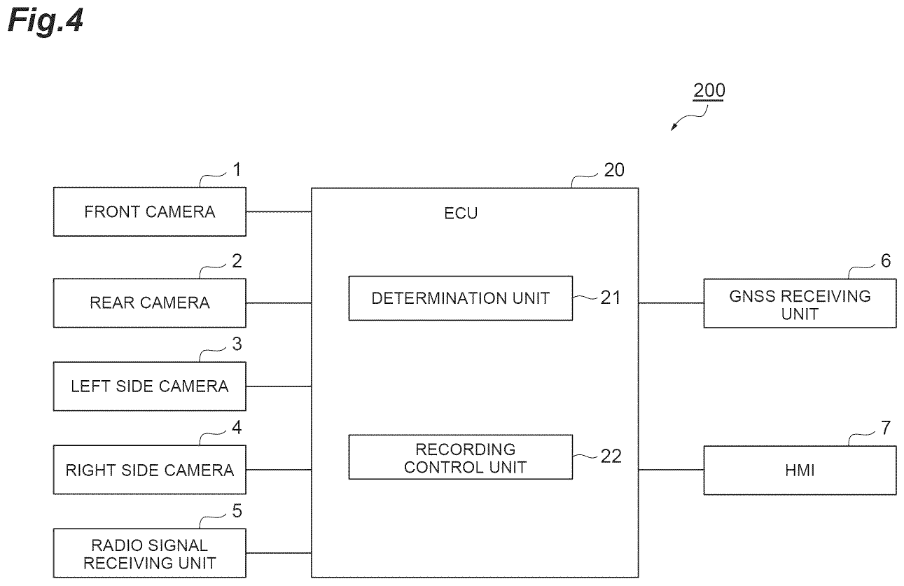

FIG. 4 is a block diagram showing the vehicle surroundings monitoring apparatus 200 according to the second embodiment. The vehicle surroundings monitoring apparatus 200 shown in FIG. 4 includes a GNSS receiving unit 6 and an HMI 7 (Human Machine Interface). The GNSS receiving unit 6 measures the position of the vehicle (for example, the latitude and longitude of the vehicle) by receiving signals from positioning satellites. The GNSS receiving unit 6 transmits the measured vehicle position information to the ECU 20.

The HMI 7 is an interface for inputting and outputting information between the ECU 20 and the user. The HMI 7 includes, for example, a display, a speaker, and the like provided in the vehicle cabin. The HMI 7 performs image output on the display and audio output from the speaker in accordance with a control signal from the ECU 20. The display may be an MID [Multi Information Display] or a HUD [Head Up Display]. The HMI 7 may include various indicators.

The determination unit 21 of the ECU 20 inquires of the user via the HMI 7 whether recording is necessary under specific conditions. The condition is a case where a home Wi-Fi or Bluetooth radio signal is not received when the vehicle is parked, and the vehicle position information measured by the GNSS receiving unit 6 is included in a preset home determination range G.

The home determination range G is a range set to determine that the vehicle is parked at home from the GNSS position information (see FIG. 2A). The home determination range G is, for example, an area within a certain radius centered on the position of the user's home. The inquiry to the user about the necessity of recording may be displayed as text on the display of the HMI 7, may be inquired by voice, or may be inquired by both image and voice. The user's selection may be made by button operation or touch panel operation, or may be made by voice recognition.

The recording control unit 22 starts recording the vehicle's surrounding environment when the user selects that recording is necessary via the HMI 7. The recording control unit 22 cancels the recording of the vehicle's surrounding environment when the user selects that recording is unnecessary via the HMI 7.

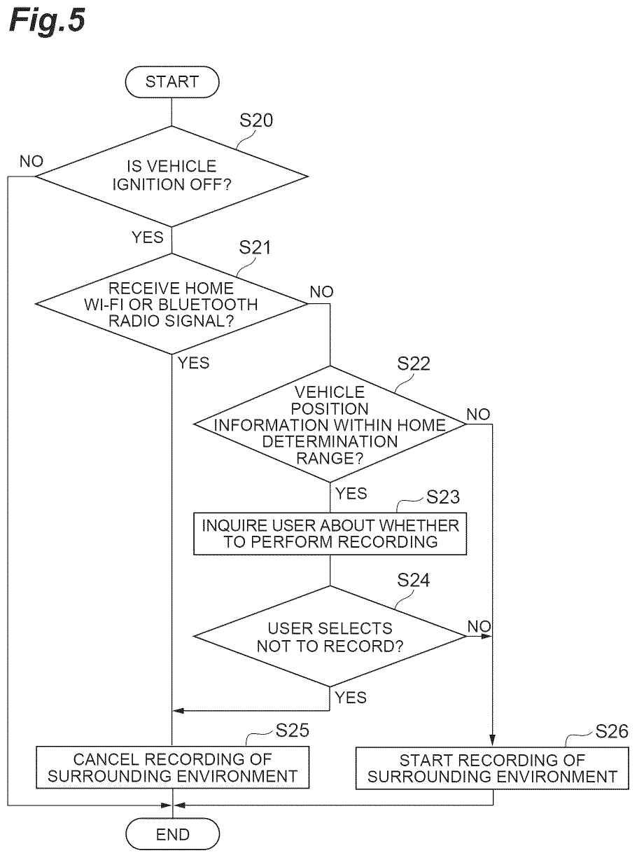

FIG. 5 is a flowchart showing an example of a vehicle surroundings monitoring process of the vehicle surroundings monitoring apparatus 200 according to the second embodiment. As shown in FIG. 5, first, the ECU 20 determines whether or not the vehicle's ignition has been turned off (S20). If the ECU 20 determines that the vehicle's ignition has been turned off (S20: YES), the process proceeds to S21. If the ECU 20 determines that the ignition has not been turned off (S20: NO), it does not start the vehicle surroundings monitoring process.

Next, the ECU 20 determines by the determination unit 21 whether or not a home Wi-Fi or Bluetooth radio signal has been received (S21). The determination unit 21 determines whether or not a home Wi-Fi or Bluetooth radio signal has been received via the radio signal receiving unit 5.

If it is determined that a home Wi-Fi or Bluetooth radio signal has been received (S21: YES), the ECU 20 determines that the vehicle is parked at home and proceeds to S25. If it is not determined that a home Wi-Fi or Bluetooth radio signal has been received (S21: NO), the ECU 20 determines that the vehicle is not parked at home and proceeds to S22.

In S22, the ECU 20 determines by the determination unit 21 whether or not the vehicle position information measured by the GNSS receiving unit 6 is within the home determination range G. If the ECU 20 determines that the vehicle position information is within the home determination range G (S22: YES), the process proceeds to S23. If the ECU 20 determines that the vehicle position information is not within the home determination range G (S22: NO), the process proceeds to S26.

In S23, the ECU 20 makes an inquiry to the user about whether to perform recording. The ECU 20 executes the inquiry to the user about the necessity of recording by image display (including text display) on the display of the HMI 7 or by voice output from the speaker. After that, the ECU 20 proceeds to S24.

In S24, the ECU 20 determines whether or not the user has selected that recording is unnecessary. If the ECU 20 determines that the user has selected that recording is unnecessary (S24: YES), the process proceeds to S25. If the ECU 20 determines that the user has not selected that recording is unnecessary (S24: NO), the process proceeds to S26. The case where the user has not selected that recording is unnecessary may include a case where a certain period of time has elapsed without the user performing an operation.

In S25, the ECU 20 cancels the recording of the vehicle's surrounding environment by the recording control unit 22. This makes it possible to suppress the execution of unnecessary recording around the user's home. After that, the ECU 20 ends the current vehicle surroundings monitoring process.

In S26, the ECU 20 causes the recording control unit 22 to start recording the vehicle's surrounding environment. The recording control unit 22 records the captured images from the front camera 1, the rear camera 2, the left side camera 3, and the right side camera 4, for example, until a predetermined time elapses or the vehicle's ignition is turned on. After that, the ECU 20 ends the current vehicle surroundings monitoring process.

The vehicle surroundings monitoring apparatus 200 according to the second embodiment has the following advantages. When a home Wi-Fi or Bluetooth radio signal is received during parking, the apparatus determines that the vehicle is parked at the user's home and does not perform recording. This can prevent recording cancellation caused by the coarse position accuracy of GNSS (that is, recording cancellation at a location where recording should be performed). Also, there may be cases where the home Wi-Fi radio signal is not received, and the vehicle's position information is included in the preset home determination range. In this case, the apparatus inquires of the user about the necessity of recording. This function improves the accuracy of position determination and achieves both suppression of unnecessary recording and securing of necessary recording.

Although the embodiments of the present disclosure have been described above, the present disclosure is not limited to the above-described embodiments. The present disclosure can be implemented in various forms with various changes and improvements based on the knowledge of those skilled in the art, including the above-described embodiments.

The vehicle-mounted cameras used by the vehicle surroundings monitoring apparatuses 100, 200 do not necessarily need to be provided so as to be able to capture images of the entire surroundings of the vehicle. The vehicle-mounted camera may be only the front camera 1, or may be only the front camera 1 and the rear camera 2. It is not always necessary to inquire of the user about the necessity of recording.

What is claimed is:

1. A vehicle surroundings monitoring apparatus that records a surrounding environment of a parked vehicle using a vehicle-mounted camera, the apparatus comprising:
a determination unit that determines whether the vehicle is parked at a user's home by receiving a radio signal; and
a recording control unit that does not record the surrounding environment of the vehicle when the determination unit determines that the vehicle is parked at the user's home.

2. The vehicle surroundings monitoring apparatus according to claim 1, wherein
the radio signal is a Wi-Fi radio signal of the home, and
the determination unit determines that the vehicle is parked at the home when the Wi-Fi radio signal of the home is received when the vehicle is parked.

3. The vehicle surroundings monitoring apparatus according to claim 2, further comprising a GNSS receiving unit that acquires position information of the vehicle by means of radio signals from positioning satellites, wherein, when the Wi-Fi radio signal of the home is not received when the vehicle is parked, and when the position information of the vehicle is included in a preset home determination range, the determination unit makes an inquiry to the user about whether to record.

4. The vehicle surroundings monitoring apparatus according to claim 1, wherein
the radio signal is the Bluetooth radio signal of the home, and
the determination unit determines that the vehicle is parked at the home when the Bluetooth radio signal of the home is received when the vehicle is parked.

5. The vehicle surroundings monitoring apparatus according to claim 4, further comprising a GNSS receiving unit that acquires position information of the vehicle by means of radio signals from positioning satellites, wherein, when the Bluetooth radio signal from the user's home is not received when the vehicle is parked, and when the position information of the vehicle is included in a preset home determination range, the determination unit makes an inquiry to the user about whether to perform recording.
